(19) United States
(12) Patent Application Publication
(10) Pub. No.: US 2002/0186407 A1
(43) Pub. Date: Dec. 12, 2002

(54) Printer-embedded service to allow for fail-over operation through automatic rerouting of print jobs to comparable printers

(76) Inventor: John David Laughlin, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/880,023

(22) Filed: Jun. 12, 2001

(51) Int. Cl. G06K 1/00; G06F 15/00

(52) U.S. Cl. 358/1.15; 358/1.14

(57) ABSTRACT

This invention relates to a scheme in which a printer that is out of service would contain an embedded service that would communicate with a network directory service to locate another printer capable of completing the print job and rerouting the print job automatically. This embedded service within the printer would then communicate with the print server to notify the user of the rerouting.

### FIELD OF THE INVENTION

This invention relates to a scheme in which a printer that is out of service would contain an embedded service that would communicate with a network directory service to locate another printer capable of completing the print job and rerouting the print job automatically. This embedded service within the printer would then communicate with the print server to notify the user of the rerouting.

### DESCRIPTION OF THE RELATED ART

Typically, users prepare a document to be printed and send that document to a printer or printing device. If that printer is out of service for some reason, such as out of paper, out of a specific type of required media or marking agent (toner, ink, etc.), jammed, off-line or the like, the user would receive notification of this after some specified time out. The user would then have to manually remove the print job from the out of service printer's queue, manually locate another printer capable of printing the print job, and manually resend the print job to the new printer. Consequently, a more advantageous printer, then, would be presented if it had a fail-over operation that allowed the printer to transfer the print job to another printer and notify the user of the transfer.

It is also known, in printing art, to employ a printer or printing device that is capable of transferring the print job to another printer, notifying the user of the print job transfer, and prompting the user to select whether or not the user wants the print job transferred. Exemplary of such prior art are U.S. Pat. No. 5,179,637 ('637) to F. M. Nardozzi, entitled “Method and Apparatus for Distributing Print Jobs Among a Network of Image Processors and Print Engines,” U.S. Pat. No. 5,287,194 ('194) to M. F. Lobiondo, entitled “Distributed Printing,” U.S. Pat. No. 5,627,658 ('658) to T. W. Connors et al., entitled “Automatic Networked Facsimile Queuing System,” and U.S. Pat. No. 6,157,465 ('465) to A. R. Suda et al., entitled “System for Transferring Jobs Between Processing Units Based Upon Content of Job and Ability of Unit to Perform Job.” While the printing systems in the above-identified references can transfer a print job and notify the user of the print job transfer, these references do not employ a printer which contains an embedded service that communicates with a network directory service to locate another printer, among a set of heterogeneous printers, capable of completing the print job and rerunning the print job automatically.

It is apparent from the above that there exists a need in the art for a printer which contains an embedded service that communicates with a network directory service to locate another printer capable of completing the print job and rerunning the print job automatically. It is a purpose of this invention to fulfill this and other needs in the art in a manner more apparent to the skilled artisan once given the following disclosure.

### SUMMARY OF THE INVENTION

Generally speaking, this invention fulfills these needs by providing a method for using a printer embedded service to allow for fail-over operation through automatic rerouting of print jobs to a comparable printer, comprising the steps of: preparing a print job; forwarding the print job to a first printer; determining if the first printer can complete the print job; employing a printer embedded service to locate a comparable printer if the first printer cannot complete the print job; and transferring the print job to the comparable printer to print the print job.

In certain preferred embodiment, the step of employing a printer embedded service includes the steps of communicating with a network directory service located on a computer on the network, using the network directory to locate another capable printer, and automatically rerouting the print job to that other capable printer.

In another further preferred embodiment, the users get their print jobs printed automatically by taking advantage of all network printer resources in the case of a printer failure, instead of having to manually discover the failure, remove print jobs from the failed printer's queue, manually locate another printer capable of printing the print job, and manually resending the print job to the new printer.

The preferred printer, according to this invention, offers the following advantages: excellent economy; ease-of-use; reduced user downtime; automatic print job forwarding; automatic locating of capable printers; and reduced print job completion time. In fact, in many of the preferred embodiments, these factors of reduced user downtime, automatic forwarding of the print job, automatic locating of capable printers, and reduced print job completion time are optimized to an extent that is considerably higher than heretofore achieved in prior, known printers.

The above and other features of the present invention, which will become more apparent as description proceeds, are best understood by considering the following detailed description in conjunction with the accompanying drawings, wherein like characters represent like parts throughout the several views and in which:

### BRIEF DESCRIPTION OF THE DRAWINGS

FIG. 1 is a flowchart that illustrates a method for using a printer embedded service to allow for fail-over operation through automatic rerouting of print jobs to comparable printers, according to one embodiment of the present invention;

FIG. 2 is a flowchart that illustrates how the out of service printer finds another capable printer, according to another embodiment of the present invention; and

FIG. 3 is a schematic illustration of a system that uses a printer embedded service to allow for fail-over operation through automatic rerouting of print jobs to comparable printers, according to yet another embodiment of the present invention.

### DETAILED DESCRIPTION OF THE INVENTION

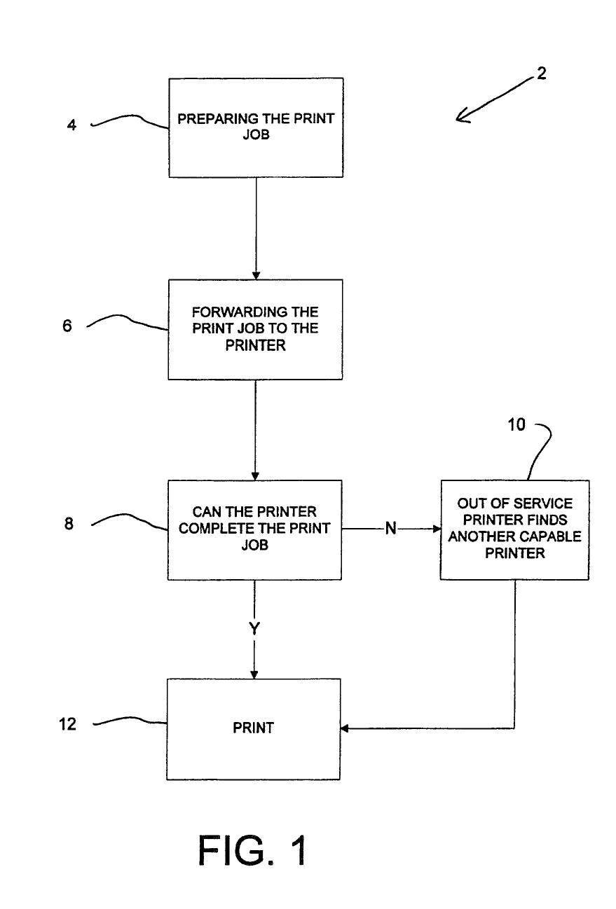

With reference first to FIG. 1, there is illustrated one preferred embodiment for use of the concepts of this invention. FIG. 1 is a flowchart that illustrates a method 2 for using a printer embedded service to allow for fail-over operation through automatic rerouting of print jobs to comparable printers. In particular, method 2 includes the steps of conventionally preparing a print job 4, conventionally forwarding the print job to the printer 6, determining if the printer can complete the print job 8, allowing the out of service printer to find another capable printer 10, and printing the print job 12. It is to be understood that while a printer is being utilized in one preferred embodiment of the present invention, the present invention can also be applied to any type of printing device, including, but not limited to, facsimile machines, copiers or the like. Also, the phrase “fail-over” refers to the ability of the printer to recognize an out of service condition and forward the print job to another capable printer.

During the operation of method 2, a user conventionally prepares print job, as shown in step 4. The print job is conventionally forwarding to the desired printer, as shown in step 6. In step 8, the printer determines whether or not it can complete the print job. As shown in step 10, if the printer cannot complete the print job because it is out of service, such as out of paper, out of a specific type of required media or marking agent (toner, ink, etc.), jammed, off-line or the like, the printer finds another capable printer, which will be discussed in detail later. If the printer is capable of completing the print job, the printer merely prints the print job, as shown in step 12.

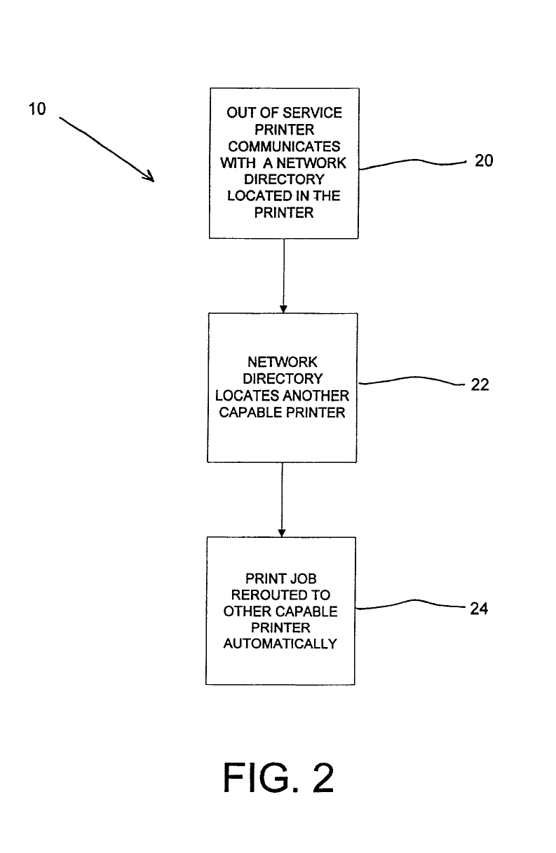

With respect to FIG. 2, there is illustrated a flowchart that shows how the out of service printer finds another capable printer. In particular, once it is determined that the printer is out of service, the out of service printer communicates with a network directory located in the printer, as shown in step 20. Preferably, the network directory is a directory service that is capable of recording the capabilities of its printing devices as attributes, such as an X.500 compatible directory service or the like. The network directory service locates another capable printer, as shown in step 22. It is to be understood that the term “capable” refers to a printer which has the same or similar operating characteristics of the first printer, namely those printers have the same or similar color vs. monochrome, duplex, stapling, sorting, installed media or the like operating characteristics. When a capable printer has been located by the network directory, the print job is automatically rerouted to that capable printer and printed by the capable printer, as shown in step 24 and the user is notified of the automatic rerouting of the print job.

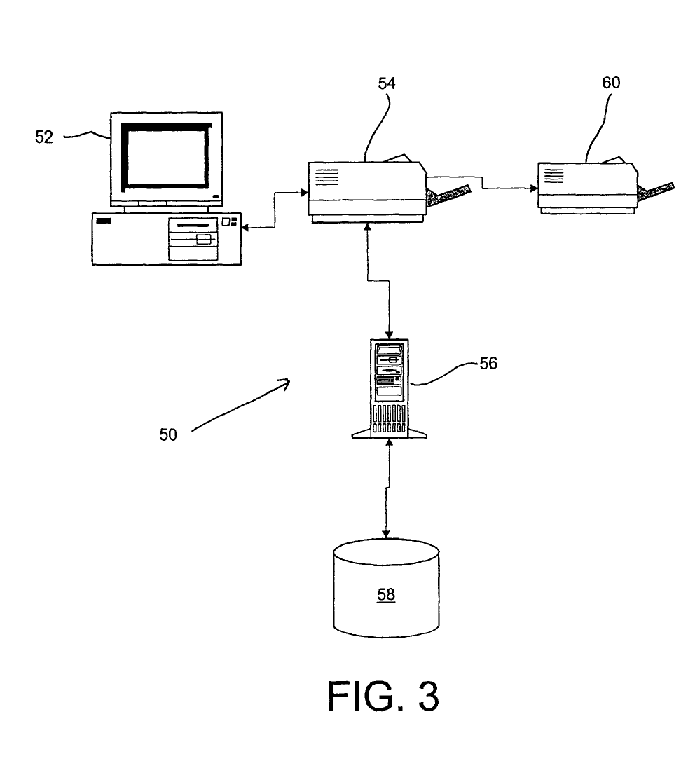

FIG. 3 illustrates a system 50 that utilizes a printer embedded service to allow for fail-over operation through automatic rerouting of print jobs to comparable printers. As shown in FIG. 3, the user (not shown) prepares a document to be printed on a conventional word processing device 52 and sends to document to a conventional printer 54 that is conventionally attached to a network along with server 56, database 58, and comparable printer 60. If printer 54 determines that it cannot print the document, as discussed above, printer 54 queries the network directory service located on server 60 and database 58 for available, comparable printing devices. Server 60 interacts with database 58 to find available, comparable printing devices. A list of available, comparable printing devices, such as printer 60, is forwarded to printer 54. Printer 54 can then select an available, comparable printing device, such as printer 60 and automatically rerout the print job to printer 60, while sending notification of the automatic rerouting to the user.

Once given the above disclosure, many other features, modifications or improvements will become apparent to the skilled artisan. Such features, modifications or improvements are, therefore, considered to be a part of this invention, the scope of which is to be determined by the following claims.

What is claimed is:

1. A method for using a printer embedded service to allow for fail-over operation through automatic rerouting of print jobs to a comparable printer, wherein said method is comprised of the steps of:
preparing a print job;
forwarding said print job to a first printer;
determining if said first printer can complete said print job;
employing a printer embedded service to locate a comparable printer if said first printer cannot complete said print job; and
transferring said print job to said comparable printer to print said print job.

2. The method, as in claim 1, wherein said determining step is further comprised of the step of:
determining if said first printer is out of service.

3. The method, as in claim 2, wherein said out of service determining step is further comprised of the step of:
determining if said first printer is out of paper.

4. The method, as in claim 2, wherein said out of service determining step is further comprised of the step of:
determining if said first printer is out of marking agent.

5. The method, as in claim 2, wherein said out of service determining step is further comprised of the step of:
determining if said first printer is out of a specific type of required media.

6. The method, as in claim 2, wherein said out of service determining step is further comprised of the step of:
determining if said first printer is jammed.

7. The method, as in claim 2, wherein said out of service determining step is further comprised of the step of:
determining if said first printer is off-line.

8. The method, as in claim 1, wherein said employing step is further comprised of the steps of:
using said first printer to communicate with a network directory;
using said network directory to locate said comparable printer; and
automatically rerouting said print job to said comparable printer.

9. The method, as in claim 8, wherein said network directory is further comprised of:
a network directory service which records capabilities of its printing devices as attributes.

10. The method, as in claim 9, wherein said network directory is further comprised of:
an X.500 compatible directory service.

11. A method for using a printing device embedded service to allow for fail-over operation through automatic rerouting of print jobs to comparable printing devices, wherein said method is comprised of the steps of:
preparing a print job;
forwarding said print job to a first printing device;
determining if said first printing device can complete said print job;
employing a printing device embedded service to locate a comparable printing device if said first printing device cannot complete said print job; and
printing said print job.

12. The method, as in claim 11, wherein said determining step is further comprised of the step of:
determining if said first printing device is out of service.

13. The method, as in claim 12, wherein said out of service determining step is further comprised of the step of:
determining if said first printing device is out of paper.

14. The method, as in claim 12, wherein said out of service determining step is further comprised of the step of:
determining if said first printing device is out of marking agent.

15. The method, as in claim 12, wherein said out of service determining step is further comprised of the step of:
determining if said first printing device is out of a specific type of required media.

16. The method, as in claim 12, wherein said out of service determining step is further comprised of the step of:
determining if said first printing device is jammed.

17. The method, as in claim 12, wherein said out of service determining step is further comprised of the step of:
determining if said first printing device is off-line.

18. The method, as in claim 11, wherein said employing step is further comprised of the steps of:
using said first printing device to communicate with a network directory;
using said network directory to locate said comparable printing device; and
automatically rerouting said print job to said comparable printing device.

19. The method, as in claim 18, wherein said network directory is further comprised of:
a network directory service which records capabilities of its printing devices as attributes.

20. The method, as in claim 19, wherein said network directory is further comprised of:
an X.500 compatible directory service.
